(19) United States
(12) Patent Application Publication
(10) Pub. No.: US 2026/0102998 A1
(43) Pub. Date: Apr. 16, 2026

(54) METAL RECOVERY MACHINE AND METHOD OF METAL REMOVAL FROM METAL CONTAINING LAMINATES

(71) Applicant: Arista Construction Systems FZE, Dubai (AE)

(72) Inventor: Manish SETH, Burnaby (CA)

(21) Appl. No.: 19/420,317

(22) Filed: Dec. 15, 2025

Related U.S. Application Data
(63) Continuation of application No. PCT/EP2024/066664, filed on Jun. 14, 2024.
(60) Provisional application No. 63/508,711, filed on Jun. 16, 2023.

(51) Int. Cl. B32B 43/00; C22B 7/00

(52) U.S. Cl. CPC B32B 43/006; C22B 7/005; B32B 2311/24

(57) ABSTRACT

A metal recovery system utilizes a metal recovery machine for metal removal from metal containing laminates, such as polymer films containing a layer of metal. A laminate may include a metal layer on a backing. The laminate may be stretched while being heated to cause the metal layer to separate from the backing and form cracks that aid in the separation of the metal from the backing. The laminate may be passed through an inlet roller into a heater, such as an oven, before passing over an outlet roller. The outlet roller may have a higher speed imparted on the laminate than the inlet roller, thereby causing the laminate to stretch while being heated by the heater. Metal removal devices such as brushes and a vacuum may be used to remove metal from the laminate.

### FIELD OF THE INVENTION

This application is a continuation of International Patent Application No. PCT/EP2024/066664, filed on Jun. 14, 2024, which claims the benefit of priority to U.S. Provisional Patent Application No. 63/508,711 filed on Jun. 16, 2023; the entirety of which is hereby incorporated by reference herein.

### BACKGROUND OF THE INVENTION

### Field of the Invention

The invention relates to a metal recovery machine and method of metal removal from metal containing laminates, such as polymer films containing a layer of metal.

### Background

Many laminates contain a layer of metal to reduce permeation and through the laminate or for reflective purposes. Building wrap and roofing underlayment materials may contain a layer of metal to reduce permeation through the material for better insulation. Many food packaging materials contain a layer of metal to reduce gas permeation to preserve food contained within an enclosure made of the laminate. These metal foil layers may be vapor deposited layers, or foils that are laminated to a backing material. The metal layer is not easily removed for recycling purposes.

### SUMMARY OF THE INVENTION

The invention is directed to a metal recovery system that utilizes a metal recovery machine for metal removal from metal containing laminates, such as polymer films containing a layer of metal. A laminate may include a metal layer on a backing. The laminate may be stretched while being heated to cause the metal layer to separate from the backing and form cracks that aid in the separation of the metal from the backing. The laminate may be passed through an inlet roller into a heater, such as an oven before passing over an outlet roller. The outlet roller may have a higher speed imparted on the laminate than the inlet roller, thereby causing the laminate to stretch while being heated by the heater. The inlet roller and outlet roller may have a pinch roller to pinch the laminate therebetween to prevent slipping of the laminate during stretching.

The metal layer may be a metal foil and the metal layer may be coupled to the backing material by an adhesive. The backing material may be a thermoplastic polymer and may form the adhesive with the metal layer, whereby the metal may be bonded by melting the thermoplastic. A separate adhesive may be used however to bond the metal layer to the backing material.

The metal may be a very thin layer, such as a vapor deposited layer having a thickness of no more than about 20 μm (micro meters), or no more than about 10 μm or even no more than about 5 μm. Alternatively, the metal layer may be a foil having a thickness of about 5 μm or more about 10 μm or more, about 20 μm or more, about 40 μm or more, about 80 μm or more, about 100 μm or more and any range between and including the thickness values provided.

A metal layer may contain any type of metal but typical metals used in home covering material and food packaging include aluminum or nickel. Other metals that might be used include, but are not limited to, gold, silver, copper and alloys such as titanium.

The metal recovery machine stretches the laminate a stretch ration, while being heated to form cracks in the metal layer and to separate the metal from the laminate. The ratio of speed of the outlet roller to the inlet roller produces a stretch ratio of the laminate that may be about 1.05:1 or more, about 1.1:1 or more, about 1.2:1 or more, about 1.3:1 or more, about 1.5:1 or more, about 2.0:1 or more and any range between and including the ratios provided. The higher the ratio, the more the metal layer may be cracked or the wider the cracks in the metal layer which may aid in removal of the metal from the laminate. Some laminates may not be able to stretched to a high degree and therefore the lower ratios may be utilized.

The inlet roller, outlet roller and respective pinch rollers may comprise an elastomeric covering to provide better grip and friction for the laminate to prevent slipping of the laminate. An elastomer used on the roller may be silicone or urethane.

An exemplary metal recovery machine may comprise metal removal devices to aid in removal of the metal from the laminate, such as brushes, vacuum and the like. A brush may be a brush roller that rotates in a counter direction to the direction of the laminate to brush off the metal from the laminate. A vacuum may be configured proximal to the laminate to such metal, such as metal fragments from the laminate after stretching while heated.

A removal device may include a magnet that draws the metal off from the backing material. A magnet may be an electromagnet that can be activated when proximal to the backing material and then deactivated when moved away from the backing material to enable the magnetically attracted metal to be removed from the removal device.

The backing material of the laminate may be a plastic, such as a thermoplastic including, but not limited to, polyolefins, polyethylene, polyester, acrylic, polypropylene and the like. The laminate may be heated to a temperature to enable the laminate to be stretched and may be near or above the melting temperature of the thermoplastic of the backing material, such as about 75% of the melting temperature, about 85% of the melting temperature, about 90% of the melting temperature, or even above the melting temperature for a very short time. For example, a thermoplastic backing material may have a melting temperature of 200° C., as determined by a dynamic scanning calorimeter (DSC) and the laminate may be heated to about 150° C. or more, 75% of the melting temperature, or 180° C. or more, 90% of the melting temperature.

A cover layer may be removed prior the laminate being stretched to produce cracks in the metal layer or after the laminate has been heated and stretched. The laminate described herein may be a roofing underlayment laminate or a house wrap or cover material. These materials may have adhesive layers bonding the metal layer to the backing and surface cover layers, or these layers may be adhered by melting the polymers. There may also be an adhesive layer on the backing layer opposite of the metal layer which may not require a release liner.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a cross sectional view of a laminate comprising a backing material and a metal layer.

FIG. 2 shows a side view of an exemplary metal recovery machine comprising an inlet roller and an outlet roller that pulls a laminate through a heater, such as an oven, to induce cracks in the metal layer by stretching the laminate while heated.

FIG. 3 shows a metal side of a laminate having cracks in the metal layer formed by stretching the laminate while being heated.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

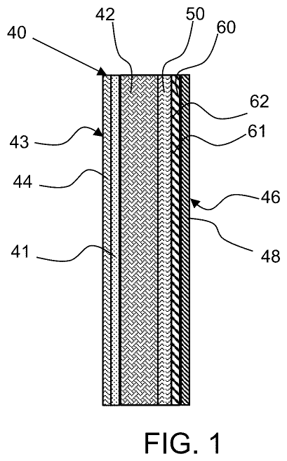

FIG. 1 shows a cross sectional view of a laminate 40 comprising a backing material 42 on a backing side 43 and a metal layer 60 on a metal side 46 of the laminate. The metal layer 60 may be a metal foil 62 of a metal 61 such as aluminum, and the metal layer may be coupled to the backing material 42 by an adhesive 50. The backing material may be a thermoplastic polymer and may form the adhesive with the metal layer 60, whereby the metal may be bonded by melting the thermoplastic. An adhesive layer 41 may be configured over the backing material 42 and a release liner 44 may be configured over the adhesive layer. A cover layer 48 may be configured over the metal layer 60 and may be adhered to the metal layer by melting the cover layer or with a separate adhesive layer (not shown in FIG. 1). A cover layer may be laid on or temporarily configured over the metal layer 60 prior to the laminate 40 being stretched.

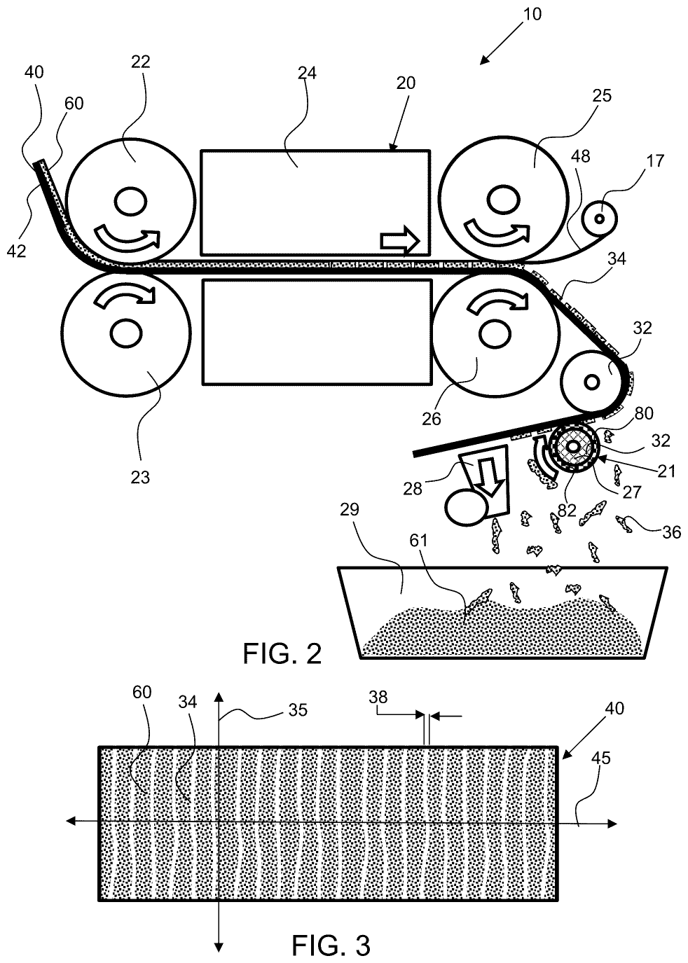

Referring now to FIGS. 2 and 3, an exemplary metal recovery system 10 utilizes a metal recovery machine 20 that comprises an inlet roller 22 and an outlet roller 25 that pulls a laminate 40 through a heater 24, such as an oven, to induce cracks 34 in the metal layer by stretching the laminate while heated. The outlet roller 25 may be pressed toward an outlet pinch roller 26 to enable the laminate 40 to be pulled while being heated to stretch the laminate 40. Likewise, the inlet roller 22 may be pressed toward an inlet pinch roller 23 to retain the laminate during heating and stretching. The ratio of speed of the outlet roller to the inlet roller may be about 1.05:1 or more, about 1.1:1 or more, about 1.2:1 or more, about 1.3:1 or more, about 1.5:1 or more, about 2.0:1 or more and any range between and including the ratios provided. The higher the ratio, the more the metal layer may be cracked or the wider the cracks in the metal layer which may aid in removal of the metal from the laminate. Some laminates may not be able to stretched to a high degree and therefore the lower ratios may be utilized.

As shown in FIG. 2, a cover layer 48, extending over the metal layer 60, is being removed by a cover layer removal roller 17 to expose the metal layer 60 and metal fragments 36. The metal layer 60 is configured up so that metal fragments 36 do not fall off prior to exiting the outlet rollers and falling into the heater 24. As the laminate exits the heater 24 and passes through the outlet rollers, it is passed over a removal roller 32 that inverts the laminate 40 such that the metal layer 60 is now configured down to aid in removal and allow gravity to enable the metal fragments 36 to fall off the laminate. A removal device 27, such as a brush, which may be configured in a brush roller that spins counter to the direction of the laminate may aid in removal of the metal 61 from the backing material 42. Also, a vacuum 28 may be configured to suck metal fragments 36 from the laminate 40. A collection bin 29 may be configured under the metal removal station 21 of the metal recovery machine 20 to collect the metal 61.

A removal device 27 may include a magnet 80 that draws the metal off from the backing material 42. A magnet may be an electromagnet 82 that can be activated when proximal to the backing material and then deactivated when moved away from the backing material to enable the magnetically attracted metal to be removed from the removal device. A magnet may be configured on a removal roller 32 that includes a brush or abrasive surface. An electromagnet configured on a roller may be activated to be magnetic when the electromagnet is proximal to the laminate and then deactivated to not be magnetic as the electromagnet rotates away from the laminate to enable the metal fragments coupled thereto to fall off, or be scraped off. A removal device may include a plurality of electromagnets configured circumferentially about a removal roller and they may activate each in sequence as they rotate toward the laminate and then deactivate in sequence as the removal roller rotates each magnet away from the laminate 40.

As shown in FIG. 3, a laminate 40 has a metal layer 60 on the metal side 46 of the laminate with cracks 34 in the metal layer formed by stretching the laminate while being heated. The cracks 34 extend in a width direction 35 that is substantially orthogonal to the length axis 45 of the laminate 40, or within about 20 degrees of orthogonal. The cracks may be jagged and may extend all the way across the width of the laminate or may extend only partially across the laminate. The cracks may have a crack width 38 of about 2 mm or more, about 4 mm or more, about 5 mm or more, about 10 mm or more, about 20 mm or more and any range between and including the crack width values provided. A larger crack width may enable the metal layer 60 to be more easily removed from the backing material.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A metal recovery system for removing metal from a laminate comprising:
a) said laminate comprising:
i) a backing side;
ii) a metal side;
iii) a backing material; and
iv) a metal layer containing metal;
b) an inlet roller;
c) an outlet roller;
d) a heater configured between the inlet roller and outlet roller configured to heat the laminate; and
e) a metal removal device comprising a a brush;
wherein the outlet roller has a speed that is greater than the inlet roller to stretch the laminate between the inlet roller and outlet roller.

2. The metal recovery system of claim 1, wherein the metal removal device further comprises a vacuum.

3. The metal recovery system of claim 1, wherein the backing material is a thermoplastic.

4. The metal recovery system of claim 1, wherein the metal removal device further comprises a magnet.

5. The metal recovery system of claim 4, wherein the magnet is an electromagnet.

6. The metal recovery system of claim 5, wherein the metal removal device comprises a removal roller and wherein the electromagnet is configured on the removal roller.

7. The metal recovery system of claim 1, wherein the metal layer is a vapor deposited metal layer.

8. The metal recovery system of claim 1, wherein the metal layer is a metal foil.

9. The metal recovery system of claim 1, wherein the metal foil has a thickness of no more than 25 μm.

10. The metal recovery system of claim 1, wherein the metal layer comprises aluminum.

11. The metal recovery system of claim 1, wherein the laminate further comprises a cover layer configured over the metal layer on the metal side of the laminate.

12. The metal recovery system of claim 11, wherein the cover layer is removed from the laminate prior to the laminate passing by the metal removal device.

13. The metal recovery system of claim 11, wherein the metal removal device further comprises a magnet.

14. The metal recovery system of claim 13, wherein the metal removal device further comprises a vacuum.

15. The metal recovery system of claim 1, wherein the laminate is stretched a stretch ratio between the inlet roller and outlet roller of 1.2:1 or more.

16. A method of recovering metal from a laminate comprising:
a) providing a metal recovery machine as described in claim 1;
b) heating the laminate with the heater;
c) stretching the laminate between the outlet roller and the inlet roller; and
d) removing metal from the laminate with the metal removal device.

17. The method of claim 16, wherein the metal removal device further comprises a vacuum.

18. The method of claim 16, wherein the backing material is a thermoplastic.

19. The method of claim 18, wherein the backing material is heated to at least 75% of the melting temperature.

20. The method of claim 16, wherein the metal removal device further comprises a magnet.

21. The method of claim 16, wherein the metal layer is a metal foil.

22. The method of claim 16, wherein the metal layer comprises aluminum.

23. The method of claim 16, wherein the laminate further comprises a cover layer configured over the metal layer on the metal side of the laminate, wherein the cover layer is removed from the laminate prior to the laminate passing by the metal removal device.

24. The method of claim 16, wherein the laminate is stretched a stretch ratio between the inlet roller and outlet roller of 1.2:1 or more.
